(19) United States
(12) Patent Application Publication
(10) Pub. No.: US 2013/0341245 A1
(43) Pub. Date: Dec. 26, 2013

(54) Methods and Systems for Upgrading Hydrocarbon Residuum

(71) Applicants: Jose Armando Salazar-Guillen, Reno, NV (US); Mahendra Joshi, Katy, TX (US); Dominic J. Zelnik, Sparks, NV (US)

(72) Inventors: Jose Armando Salazar-Guillen, Reno, NV (US); Mahendra Joshi, Katy, TX (US); Dominic J. Zelnik, Sparks, NV (US)

(73) Assignee: MARATHON OIL CANADA CORPORATION, Calgary (CA)

(21) Appl. No.: 13/532,453

(22) Filed: Jun. 25, 2012

(51) Int. Cl. C10G 47/02; B01D 29/00; B01J 8/00; B01J 8/18; B01D 43/00

(52) U.S. Cl. 208/108; 422/140; 422/187; 422/236

(57) ABSTRACT

A hydrocarbon upgrading method is described. The method can generally include a step of providing a nozzle reactor, a step of injecting hydrocarbon residuum into the feed passage of the nozzle reactor, and a step of injecting a cracking material into the main passage of the nozzle reactor, and a step of collecting a product stream exiting the exit opening of the main passage of the nozzle reactor. The hydrocarbon residuum used in the method can be obtained from a hydroconversion-type upgrader, such as an ebullating bed hydrocracker.

### BACKGROUND

In some typical bitumen upgrading processes, bitumen extracted from, for example, oil sands, is sent to a series of distillation towers to separate the lighter components of the bitumen from the heavier components of the bitumen. In one specific example, an atmospheric distillation tower is used to separate naphtha and light gas oil from the bitumen, followed by treating the bitumen in a vacuum distillation tower to separate vacuum gas oil from the bitumen. The heavy component of the bitumen leaving the vacuum distillation tower is sometimes referred to as oil residue.

The oil residue generally includes heavy hydrocarbon material and heavy metals, and therefore requires further processing in order to improve the usefulness of the material. In some upgrading processes, the oil residue is sent to an ebullated bed hydrocracker in order to remove the heavy metals in the oil residue and crack the large hydrocarbons. While the product stream leaving the ebullated bed hydrocracker includes some cracked hydrocarbons, the product stream continues to include unconverted heavy hydrocarbons. In some instances, anywhere from 10 wt % to 30 wt % of the ebullated bed hydrocracker product stream is made up of unconverted heavy hydrocarbons. As a result, an additional separation step is typically carried out on the ebullated bed hydrocracker product stream to separate the product stream into a lighter, converted hydrocarbon stream and an unconverted hydrocarbon residuum stream.

The unconverted hydrocarbon residuum stream generally has a low API gravity, a high viscosity, a high metal content, a high sulfur content, a high coke content, and is therefore an undesirable by-product of the upgrading process. In many currently used upgrading processes, this unconverted hydrocarbon residuum is disposed of or re-blended with lighter hydrocarbon material for transportation to refinery units. Many operators blend unconverted hydrocarbon residuum with bitumen or vacuum residuum and feed the material into a coker (e.g., a delayed coker or a flexi-coker). As a result, many currently known methods are less than optimally efficient in the conversion of the initial bitumen material into commercially useful lighter hydrocarbon material due to the failure to upgrade the unconverted hydrocarbon residuum.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a hydrocarbon upgrading method is provided. The method generally includes a first step of providing a nozzle reactor, such as the nozzle reactor described in U.S. patent application Ser. No. 13/227,470. The method can also include a step of injecting hydrocarbon residuum into the feed passage of the nozzle reactor and injecting a cracking material into the main passage of the nozzle reactor. The method can also include collecting a product stream exiting the exit opening of the main passage of the nozzle reactor. In some embodiments, the hydrocarbon residuum used in the method is obtained from a hydroconversion-type upgrader, such as an ebullating bed hydrocracker.

In some embodiments, a hydrocarbon upgrading system is provided. The system generally includes a hydroconversion-type upgrader and a nozzle reactor, such as the nozzle reactor described in U.S. patent application Ser. No. 13/227,470. In some embodiments, the system further includes a first separation unit for receiving the product produced by the hydroconversion-type upgrader. The first separation unit can provide an unconverted hydrocarbon residuum stream, which is injected into the feed passage of the nozzle reactor.

Embodiments of the method and system summarized above can provide various advantages over previously known systems and methods for upgrading bitumen, including providing a manner for upgrading hydroconversion-type upgrader-produced hydrocarbon residuum typically treated as waste product in some previously known upgrading processes and systems. Other advantages include, but are not limited to, providing a system and method capable of recovering spent catalyst from the hydroconversion-type upgrader; providing a system and method capable of collecting concentrated metals (including Ni and V); allowing hydroconversion-type upgraders to handle higher amounts of asphaltenes in the feedstock by converting unconverted hydrocarbon residue in the nozzle reactor; de-bottlenecking hydroconversion-type upgraders by improving overall hydrocarbon conversion or keeping the same conversion but increasing the throughput; providing deeper unconverted hydrocarbon residuum conversion with heavier feeds to produce more distillate barrels to take full advantage of both distillate-fuel oil and sweet-sour crude price differentials; improved product quality of products to allow for more direct blending into fuel pools with associated benefits for downstream refining units; lower greenhouse gas emissions and energy usage across the entire upgrading chain from upgrading to refining; less spent catalyst for reclamation with associated lower energy usage and greenhouse gas emissions and handling; and less hazardous waste to be transported, such as unconverted bitumen/pitch, coke, metals, etc.

These and other aspects of the present system will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 is a flow chart illustrating steps of a hydrocarbon upgrading method according to embodiments described herein;

FIG. 2 shows a cross-sectional view of one embodiment of a nozzle reactor suitable for use in embodiments described herein.

FIG. 3 shows a cross-sectional view of the top portion of the nozzle reactor shown in FIG. 2.

FIG. 4 shows a cross-sectional perspective view of the mixing chamber in the nozzle reactor shown in FIG. 2.

FIG. 5 shows a cross-sectional perspective view of the distributor from the nozzle reactor shown in FIG. 2.

FIG. 6 shows a cross-sectional view of a cross-shaped injection hole suitable for use in nozzle reactors described herein.

FIG. 7 shows a cross-sectional view of a star-shaped injection hole suitable for use in nozzle reactors described herein.

FIG. 8 shows a cross-sectional view of a lobed-shaped injection hole suitable for use in nozzle reactors described herein.

FIG. 9 shows a cross-sectional view of a slotted-shaped injection hole suitable for use in nozzle reactors described herein.

FIG. 10 shows cross-sectional views of various shapes for injection holes suitable for use in nozzle reactors described herein.

FIG. 11 is a block diagram illustrating a hydrocarbon upgrading system according to embodiments disclosed herein.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense. Weight percentages provided herein are on a dry weight basis unless otherwise indicated.

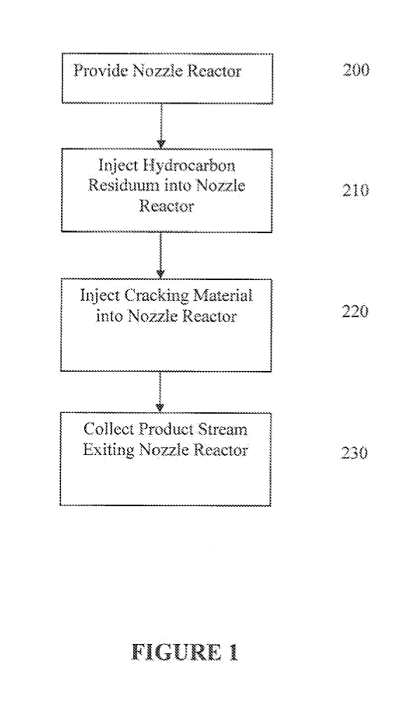

With reference to FIG. 1, some embodiments of a method of upgrading hydrocarbon described herein include a step 200 of providing a nozzle reactor, a step 210 of injecting hydrocarbon residuum into the nozzle reactor, a step 220 of injecting cracking material into the nozzle reactor, and a step 230 of collecting a product stream exiting the nozzle reactor.

Step 200 of providing a nozzle reactor generally includes providing any nozzle reactor capable of upgrading hydrocarbon through the interaction of the hydrocarbon material and a cracking material inside of the nozzle reactor. In some embodiments, the nozzle reactor is any embodiment of the nozzle reactor described in U.S. patent application Ser. No. 13/227,470, which is each hereby incorporated by reference in its entirety. The nozzle reactors described in this patent application generally receive a cracking material and accelerate it to a supersonic speed via a converging and diverging injection passage. Hydrocarbon material is injected into the nozzle reactor adjacent the location the cracking material exits the injection passage and at a direction transverse to the direction of the cracking material. The interaction between the cracking material and the hydrocarbon material results in the cracking of the hydrocarbon material into a lighter hydrocarbon material.

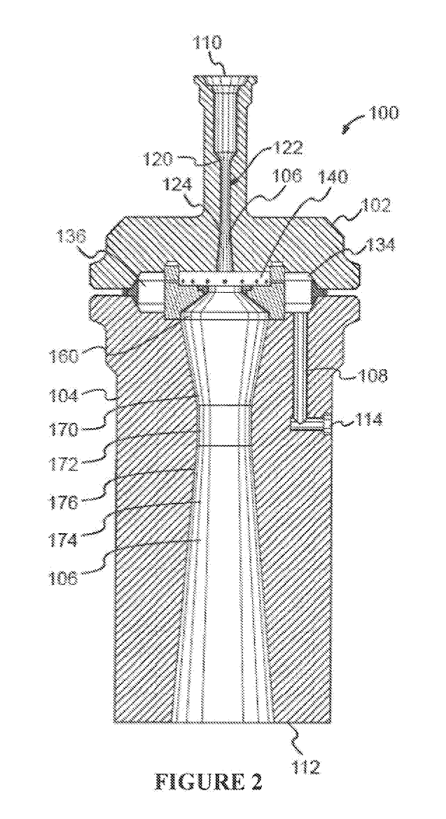

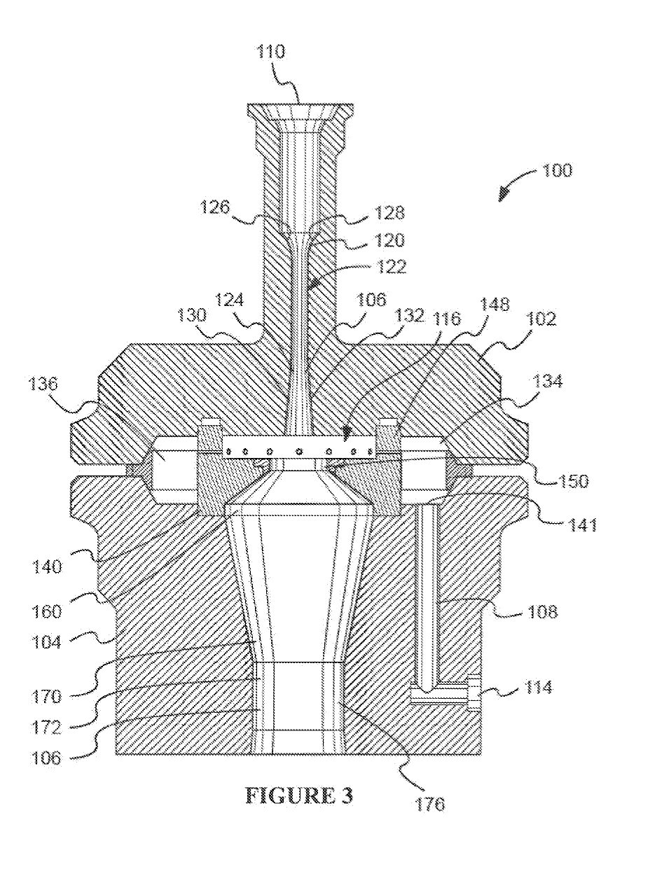

FIGS. 2 and 3 show cross-sectional views of one embodiment of a nozzle reactor 100 suitable for use in the embodiments described herein. The nozzle reactor 100 includes a head portion 102 coupled to a body portion 104. A main passage 106 extends through both the head portion 102 and the body portion 104. The head and body portions 102, 104 are coupled together so that the central axes of the main passage 106 in each portion 102, 104 are coaxial so that the main passage 106 extends straight through the nozzle reactor 100.

It should be noted that for purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

The nozzle reactor 100 includes a feed passage 108 that is in fluid communication with the main passage 106. The feed passage 108 intersects the main passage 106 at a location between the portions 102, 104. The main passage 106 includes an entry opening 110 at the top of the head portion 102 and an exit opening 112 at the bottom of the body portion 104. The feed passage 108 also includes an entry opening 114 on the side of the body portion 104 and an exit opening 116 that is located where the feed passage 108 meets the main passage 106.

During operation, the nozzle reactor 100 includes a cracking material that flows through the main passage 106. The cracking material enters through the entry opening 110, travels the length of the main passage 106, and exits the nozzle reactor 100 out of the exit opening 112. A hydrocarbon residuum flows through the feed passage 108. The hydrocarbon residuum enters through the entry opening 114, travels through the feed passage 106, and exits into the main passage 108 at exit opening 116.

The main passage 106 is shaped to accelerate the cracking material. The main passage 106 may have any suitable geometry that is capable of doing this. As shown in FIGS. 1 and 2, the main passage 106 includes a first region having a convergent section 120 (also referred to herein as a contraction section), a throat 122, and a divergent section 124 (also referred to herein as an expansion section). The first region is in the head portion 102 of the nozzle reactor 100.

The convergent section 120 is where the main passage 106 narrows from a wide diameter to a smaller diameter, and the divergent section 124 is where the main passage 106 expands from a smaller diameter to a larger diameter. The throat 122 is the narrowest point of the main passage 106 between the convergent section 120 and the divergent section 124. When viewed from the side, the main passage 106 appears to be pinched in the middle, making a carefully balanced, asymmetric hourglass-like shape. This configuration is commonly referred to as a convergent-divergent nozzle or “con-di nozzle”.

The convergent section of the main passage 106 accelerates subsonic fluids since the mass flow rate is constant and the material must accelerate to pass through the smaller opening. The flow will reach sonic velocity or Mach 1 at the throat 122 provided that the pressure ratio is high enough. In this situation, the main passage 106 is said to be in a choked flow condition.

Increasing the pressure ratio further does not increase the Mach number at the throat 122 beyond unity. However, the flow downstream from the throat 122 is free to expand and can reach supersonic velocities. It should be noted that Mach 1 can be a very high speed for a hot fluid since the speed of sound varies as the square root of absolute temperature. Thus the speed reached at the throat 122 can be far higher than the speed of sound at sea level.

The divergent section 124 of the main passage 106 slows subsonic fluids, but accelerates sonic or supersonic fluids. A convergent-divergent geometry can therefore accelerate fluids in a choked flow condition to supersonic speeds. The convergent-divergent geometry can be used to accelerate the hot, pressurized reacting fluid to supersonic speeds, and upon expansion, to shape the exhaust flow so that the heat energy propelling the flow is maximally converted into kinetic energy.

The flow rate of the cracking material through the convergent-divergent nozzle is isentropic (fluid entropy is nearly constant). At subsonic flow the material is compressible so that sound, a small pressure wave, can propagate through it. At the throat 122, where the cross sectional area is a minimum, the fluid velocity locally becomes sonic (Mach number=1.0). As the cross sectional area increases the gas begins to expand and the gas flow increases to supersonic velocities where a sound wave cannot propagate backwards through the materials as viewed in the frame of reference of the nozzle (Mach number>1.0).

The main passage 106 only reaches a choked flow condition at the throat 122 if the pressure and mass flow rate is sufficient to reach sonic speeds, otherwise supersonic flow is not achieved and the main passage will act as a venturi tube. In order to achieve supersonic flow, the entry pressure to the nozzle reactor 100 should be significantly above ambient pressure.

The pressure of the cracking material at the exit of the divergent section 124 of the main passage 106 can be low, but should not be too low. The exit pressure can be significantly below ambient pressure since pressure cannot travel upstream through the supersonic flow. However, if the pressure is too far below ambient, then the flow will cease to be supersonic or the flow will separate within the divergent section 124 of the main passage 106 forming an unstable jet that “flops” around and damages the main passage 106. In one embodiment, the ambient pressure is no higher than approximately 2-3 times the absolute pressure in the supersonic gas at the exit.

The supersonic cracking fluid collides and Mixes with the hydrocarbon residuum in the nozzle reactor 100 to produce the desired reaction. The high speeds involved and the resulting collision produces a significant amount of kinetic energy that helps facilitate the desired reaction. The cracking material and/or the hydrocarbon residuum may also be pre-heated to provide additional thermal energy to react the materials.

The nozzle reactor 100 may be configured to accelerate the cracking material to at least approximately Mach 1, at least approximately Mach 1.5, or, desirably, at least approximately Mach 2. The nozzle reactor may also be configured to accelerate the cracking material to approximately Mach 1 to approximately Mach 7, approximately Mach 1.5 to approximately Mach 6, or, desirably, approximately Mach 2 to approximately Mach 5.

As shown in FIG. 3, the main passage 106 has a circular cross-section and opposing converging side walls 126, 128. The side walls 126, 128 curve inwardly toward the central axis of the main passage 106. The side walls 126, 128 form the convergent section 120 of the main passage 106 and accelerate the cracking material as described above.

The main passage 106 also includes opposing diverging side walls 130, 132. The side walls 130, 132 curve outwardly (when viewed in the direction of flow) away from the central axis of the main passage 106. The side walls 130, 132 form the divergent section 124 of the main passage 106 that allows the sonic fluid to expand and reach supersonic velocities.

The side walls 126, 128, 130, 132 of the main passage 106 provide uniform axial acceleration of the cracking material with minimal radial acceleration. The side walls 126, 128, 130, 132 may also have a smooth surface or finish with an absence of sharp edges that may disrupt the flow. The configuration of the side walls 126, 128, 130, 132 renders the main passage 106 substantially isentropic.

The feed passage 108 extends from the exterior of the body portion 104 to an annular chamber 134 formed by head and body portions 102, 104. The portions 102, 104 each have an opposing cavity so that when they are coupled together the cavities combine to form the annular chamber 134. A seal 136 is positioned along the outer circumference of the annular chamber 134 to prevent the hydrocarbon residuum from leaking through the space between the head and body portions 102, 104.

It should be appreciated that the head and body portions 102, 104 may be coupled together in any suitable manner. Regardless of the method or devices used, the head and body portions 102, 104 should be coupled together in a way that prevents the hydrocarbon residuum from leaking and withstands the forces generated in the interior. In one embodiment, the portions 102, 104 are coupled together using bolts that extend through holes in the outer flanges of the portions 102, 104.

The nozzle reactor 100 includes a distributor 140 positioned between the head and body portions 102, 104. The distributor 140 prevents the hydrocarbon residuum from flowing directly from the opening 141 of the feed passage 108 to the main passage 106. Instead, the distributor 140 annularly and uniformly distributes the hydrocarbon residuum into contact with the cracking material flowing in the main passage 106.

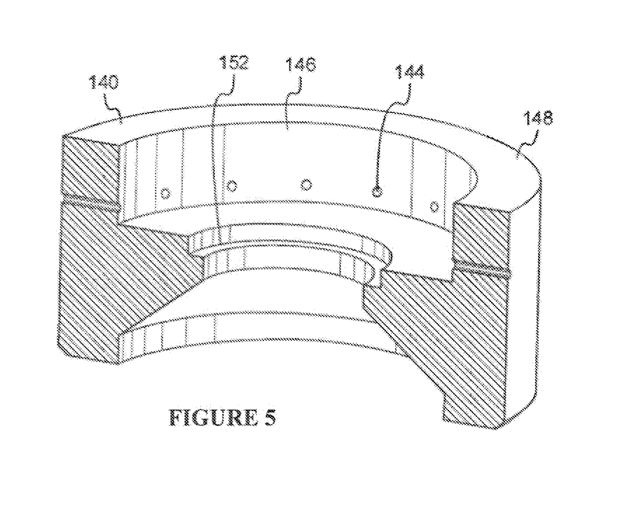

As shown in FIG. 5, the distributor 140 includes an outer circular wall 148 that extends between the head and body portions 102, 104 and forms the inner boundary of the annular chamber 134. A seal or gasket may be provided at the interface between the distributor 140 and the head and body portions 102, 104 to prevent hydrocarbon residuum from leaking around the edges.

The distributor 140 includes a plurality of holes 144 that extend through the outer wall 148 and into an interior chamber 146. The holes 144 are evenly spaced around the outside of the distributor 140 to provide even flow into the interior chamber 146. The interior chamber 146 is where the main passage 106 and the feed passage 108 meet and the hydrocarbon residuum comes into contact with the supersonic cracking material.

The distributor 140 is thus configured to inject the hydrocarbon residuum at about a 90° angle to the axis of travel of the cracking material in the main passage 106 around the entire circumference of the cracking material. The hydrocarbon residuum thus forms an annulus of flow that extends toward the main passage 106. The number and size of the holes 144 are selected to provide a pressure drop across the distributor 140 that ensures that the flow through each hole 144 is approximately the same. In one embodiment, the pressure drop across the distributor is at least approximately 2000 Pascals (Pa), at least approximately 3000 Pa, or at least approximately 5000 Pa.

Referring again to FIG. 5, holes 144 are shown having a circular cross-section. Circular holes 144 are suitable for effective nozzle reactor operation when the nozzle reactor is relatively small and handling production capacities less than, e.g., 1,000 bbl/day. At such production capacities, the hydrocarbon residuum passing through the circular holes will break up into the smaller droplet size necessary for efficient mixing or shearing with the cracking material.

As the size and production capacity of the nozzle reactor is increased, the diameter of the circular holes 144 also increases. As the diameter of the circular holes 144 increases with scale up of the nozzle reactor, the circular holes 144 eventually become too large for hydrocarbon residuum traveling therethrough to exert sufficient inertial or shear forces on the circular holes 144. As a result, the hydrocarbon residuum traveling through the holes 144 does not break up into the smaller droplets necessary for efficient mixing or shearing with the cracking material, and uniform distribution of the hydrocarbon residuum is not achieved. Instead, the hydrocarbon residuum passing through the circular holes 144 maintains a cone-like structure for a longer radial travel distance and impacts the cracking material in large droplets not conducive for intimate mixing with the cracking material. Non-uniform kinetic energy transfer from the cracking material to the large droplets of hydrocarbon residuum results and the overall conversion efficiency of the reactor nozzle is reduced.

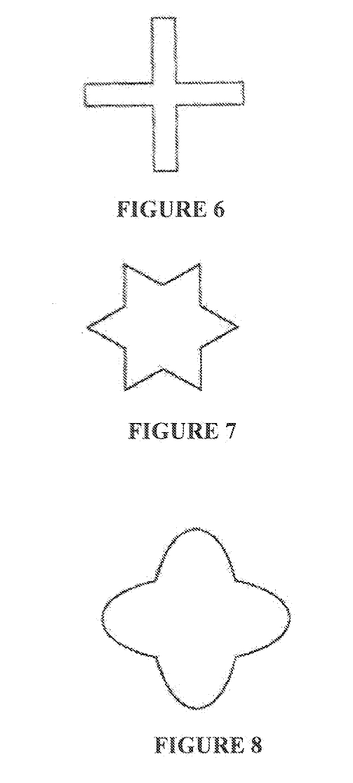

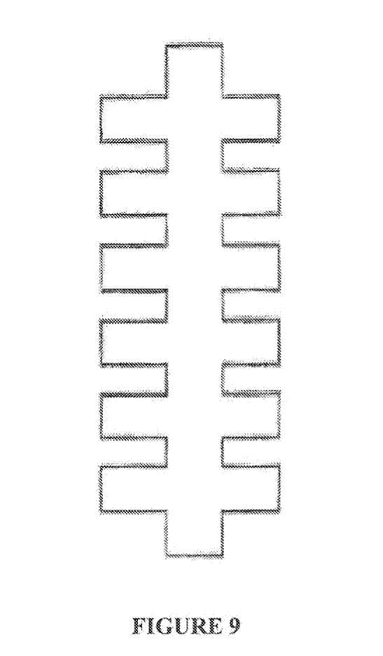

Accordingly, in some embodiments where larger nozzle reactors are used to handle higher production capacities (e.g., greater than 1,000 bbl/day), the injection holes 144 can have a non-circular cross-sectional shape. FIGS. 6-9 illustrate several non-circular shapes that can be used for injection holes 144. In FIG. 6, a cross-shaped injection hole is shown. In FIG. 7, a star-shaped injection hole is shown. In FIG. 8, a lobed-shaped injection hole is shown. In FIG. 9, a slotted-shaped injection hole is shown. Other non-circular shapes, such as rectangular, triangular, elliptical, trapezoidal, fish-eye, etc., not shown in the Figures can also be used.

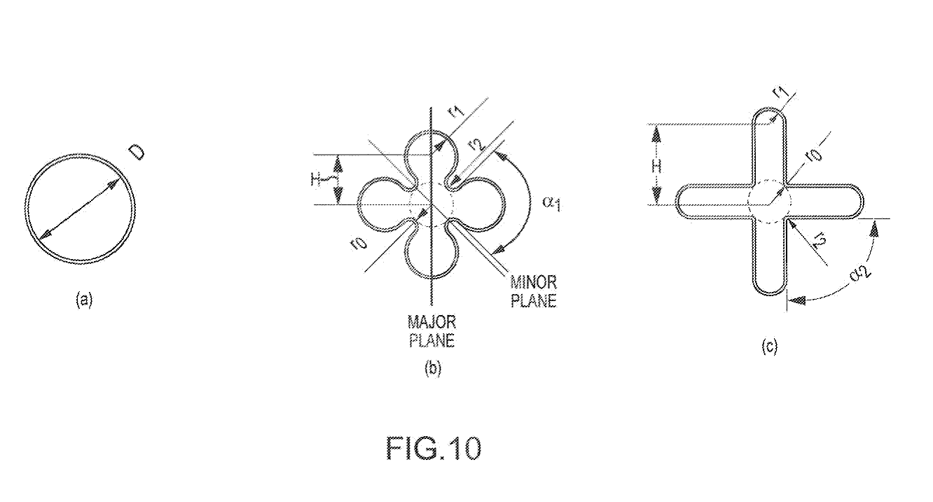

In some embodiments, the cross-shaped injection hole is a preferred cross-seqtional shape. The cross-shaped injection holes can extend the maximum oil flow capacity at a given conversion rate by at least 20 to 30% over circular injection holes having similar cross-sectional areas. With reference to FIG. 10, various dimensions of the cross-shaped injection hole are labeled, including r₀, r₁, r₂, and H. In some embodiments, the cross-shaped injection hole has dimensions according to the following ratios: r₀/r₁=1.2 to 2.0, preferably 1.5; H/r₀=3 to 4, preferably 3.5, and r₂/r₁=0.25 to 0.75, preferably 0.5.

Changing the aspect ratio of the non-circular injection holes along the major and/or minor axis can varying the level of shear or turbulence generated by the cracking material. Generally, elongated thin slots, or shapes having thinner cross sections and at the same time changing orientation of slots along the circumferential direction (such as cross or lobe shape) offer the highest level of shear along the axial and circumferential jet directions. This is generally due to generation of Helmholtz vortices along various axes. The individual vortices develop in pairs with counter rotating directions. The counter rotating vorticies contribute to increased shearing of jet and entrainment of surrounding fluids.

The cross-sectional area of the non-circular injection holes is generally not limited. In some embodiments, the cross-sectional area of the non-circular injection holes is designed for required oil flow capacity for optimum conversion at a given oil supply pressure (e.g., 100 to 150 psig)

Any suitable manner for manufacturing the non-circular injection holes can be used. In some embodiments, the non-circular injection holes are cut using a water jet cutting process or Electro Discharge Machining (EDM). In some embodiments, the internal surfaces of the non-circular injection holes are smooth. The internal surfaces can be made smooth using any suitable techniques, including grinding, polishing, and lapping. Smooth internal surfaces can be preferred because they produce smaller droplets of feed material than when the internal surface of the injection hole is rough.

Other parameters that have been found to impact the size of the feed material droplets include the hydrocarbon residuum pressure on the injection hole (increased pressure result in smaller droplet size), the viscosity of the hydrocarbon residuum (lower viscosity hydrocarbon residuum has smaller droplets), and the spray angle (smaller spray angles provide smaller droplets). Accordingly, one or more of these parameters can be adjusted in the nozzle reactor in order to produce the smaller hydrocarbon residuum droplets that lead to better mixing with the cracking material.

Adjusting the cross-section shape of holes 144 in order to allow for scale up of the nozzle reactor without negatively impacting the performance of the nozzle reactor can be preferable to using multiple smaller nozzle reactors arranged in parallel. In the parallel nozzle reactors configuration, each nozzle reactor handles a small portion of overall production capacity and allows for the continued use of circular holes 144. However, while this method will maintain adequate mixing and conversion per nozzle reactor, it will also result in higher capital costs associated with nozzle reactors and the piping needed for feed distribution and collecting converted products.

In some embodiments, throat 122 and divergent section 124 of main passage 106 can also have a non-circular cross section, such as the cross shape, lobe shape, or slotted shape described in greater detail above with respect to injection holes 144. Cracking material is typically injected into the nozzle reactor through this portion of the main passage 106, and by providing a non-circular cross-sectional shape, similar benefits to those described above with respect to the non-circular injection holes 144 can be achieved for the cracking material. For example, increased turbulence of the cracking material and entrainment efficiency between the cracking material and the hydrocarbon residuum can be achieved when throat 122 and divergent section 124 have a non-circular shape. As discussed in greater detail previous, increases in turbulence and entrainment efficiency can increase the conversion of large hydrocarbon molecules into smaller hydrocarbon molecules.

In some embodiments, the non-circular shape begins at the narrowest portion of the throat 122 and the non-circular shape continues the length of the divergent section 124 such that the ejection end of the divergent section 124 has the non-circular cross-section shape. The cross-sectional area in the divergent section become larger as the ejection end is approached, but the same cross-sectional shape can be maintained throughout the length of the divergent section 124. As with the injection holes 144, the interior surfaces of the throat 122 and divergent section 124 can have a smooth surface.

In some embodiments, a combination of circular and non-circular injection holes can be used within the same nozzle reactor. Any combination of circular and non-circular injection holes can be used. In some embodiments, the plurality of injection holes provided for the reacting fluid can include both circular and non-circular injection holes. In some embodiments, non-circular injection holes can be used for the cracking material while circular injection holes are used for the hydrocarbon residuum. In some embodiments, circular injection holes can be used for the cracking material while non-circular injection holes can be used for the hydrocarbon residuum.

The distributor 140 includes a wear ring 150 positioned immediately adjacent to and downstream of the location where the feed passage 108 meets the main passage 106. The collision of the cracking material and the hydrocarbon residuum causes a lot of wear in this area. The wear ring is a physically separate component that is capable of being periodically removed and replaced.

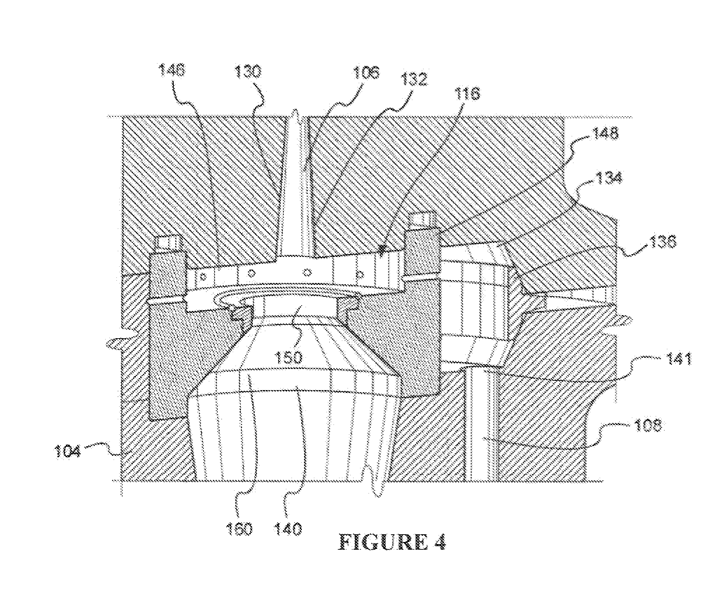

As shown in FIG. 5, the distributor 140 includes an annular recess 152 that is sized to receive and support the wear ring 150. The wear ring 150 is coupled to the distributor 140 to prevent it from moving during operation. The wear ring 150 may be coupled to the distributor in any suitable manner. For example, the wear ring 150 may be Welded or bolted to the distributor 140. If the wear ring 150 is welded to the distributor 140, as shown in FIG. 4, the wear ring 150 can be removed by grinding the weld off. In some embodiments, the weld or bolt need not protrude upward into the interior chamber 146 to a significant degree.

The wear ring 150 can be removed by separating the head portion 102 from the body portion 104. With the head portion 102 removed, the distributor 140 and/or the wear ring 150 are readily accessible. The user can remove and/or replace the wear ring 150 or the entire distributor 140, if necessary.

As shown in FIGS. 2 and 3, the main passage 106 expands after passing through the wear ring 150. This can be referred to as expansion area 160 (also referred to herein as an expansion chamber). The expansion area 160 is formed largely by the distributor 140, but can also be formed by the body portion 104.

Following the expansion area 160, the main passage 106 includes a second region having a converging-diverging shape. The second region is in the body portion 104 of the nozzle reactor 100. In this region, the main passage includes a convergent section 170 (also referred to herein as a contraction section), a throat 172, and a divergent section 174 (also referred to herein as an expansion section). The converging-diverging shape of the second region differs from that of the first region in that it is much larger. In one embodiment, the throat 172 is at least 2-5 times as large as the throat 122.

The second region provides additional mixing and residence time to react the cracking material and the hydrocarbon residuum. The main passage 106 is configured to allow a portion of the reaction mixture to flow backward from the exit opening 112 along the outer wall 176 to the expansion area 160. The backflow then mixes with the stream of material exiting the distributor 140. This mixing action also helps drive the reaction to completion.

It should be appreciated that the nozzle reactor 100 can be configured in a variety of ways that are different than the specific design shown in the Figures. For example, the location of the openings 110, 112, 114, 116 may be placed in any of a number of different locations. Also, the nozzle reactor 100 may be made as an integral unit instead of comprising two or more portions 102, 104. Numerous other changes may be made to the nozzle reactor 100.

In step 210, hydrocarbon residuum is injected into the feed passage of the nozzle reactor provided in step 200. As used herein, hydrocarbon residuum generally refers to unconverted hydrocarbon material separated from a product stream exiting a hydroconversion-type upgrader. Such hydrocarbon residuum generally includes a portion of hydrocarbons having a boiling point greater than 1,050° F. In some embodiments, the hydrocarbon residuum includes greater than 10 vol %+1,050° F. hydrocarbons, greater than 20 vol %+1,050° F. hydrocarbons, or greater than 50 vol %+1,050° F. hydrocarbons. The hydrocarbon residuum can also include hydrocarbons having a boiling point temperature less than 1,050° F. The hydrocarbon residuum can also include, for example, heavy metals, sulfur, petroleum coke particles, sand, clay, and catalyst particles from the hydroconversion-type upgrader. The hydrocarbon residuum will typically have a low API gravity and a high viscosity.

The hydroconversion-type upgrader from which the hydrocarbon-residuum is obtained can be any type of hydrocarbon upgrader known to those of ordinary skill in the art that relies upon hydroconversion to crack heavy hydrocarbon molecules into lighter hydrocarbon molecules. Hydroconversion is generally understood to include a process by which molecules are split or saturated with hydrogen gas. Hydroconversion is generally carried out at high temperatures and pressures, and in the presence of a catalyst.

An example of a hydroconversion-type upgrader suitable for use in the embodiments described herein is an ebullating bed hydrocracker. Ebullating bed hydrocrackers generally operate by providing a catalyst bed through which a hydrocarbon feed and hydrogen gas are up-flowed. The catalyst bed expands and back mixes as the hydrocarbon and hydrogen flow upwardly through the catalyst bed, and hydrocracking of the hydrocarbon material occurs. Additional catalyst is added at the top of the ebullating bed reactor. At the top of the ebullating bed reactor, upgraded hydrocarbon and hydrogen is separated and removed from the reactor, while catalyst is re-circulated to the bottom of the catalyst bed to mix with new hydrocarbon feed. The upgraded hydrocarbon and hydrogen removed from the reactor will also generally include a portion of unconverted hydrocarbon residuum due to the inability of the ebullating bed reactor to upgrade all of the hydrocarbon fed into the reactor. In some embodiments, from 5 to 10 wt % of the material exiting the reactor will be hydrocarbon residuum. An example of a commercially available ebullating bed hydrocracker is the LC-Finer manufactured by Chevron-Lummus. Another example is the H-Oil Residue Upgrader supplied by IFP and Axens.

Another example of a hydroconversion process suitable for use in embodiments described herein is a slurry hydrocracking process. In general, slurry hydroprocessing includes dispersing a selected catalyst in the hydrocarbon feed to inhibit coke formation. The hydrocarbon feed material is then processed using a commercial slurry system reactor. The process carried out in the slurry system reactor can include the Veba combi-cracking process, the Microcat-RC process, the CASH (Chevron activated slurry hydroprocessing) process, the CanMet Energy Research Laboratories process; or the EST (Eni slurry technology) process. Typical operating conditions for slurry system reactors include temperatures in a range of from 440-460° C., pressures of from 10-15 MPa, and feedstock catalyst concentrations of 30-40 wt %. The reactor product is separated and fractionated to recover distillate products and distillable residue. The conversion of high-boiling material in the bitumen or VR may be up to 70%, depending on reaction severity. The remaining 30 wt % residuum can serves as the hydrocarbon residuum introduced into the nozzle reactor.

In some embodiments, the hydrocarbon residuum is blended with other material prior to being injected into the nozzle reactor in step 210. The material with which the hydrocarbon residuum can be mixed includes lighter hydrocarbon material, such as vacuum gasoline oil (VGO) in order to improve flow characteristics. Other material that can be blended with the hydrocarbon residuum includes native bitumen, heavy oil atmospheric residue, or heavy oil vacuum residue. In some embodiments, the blended material injected into the nozzle reactor includes greater than 50 wt % hydrocarbon residuum.

The hydrocarbon residuum injected into the nozzle reactor in step 110 can also undergo solid material separation prior to injection. In some embodiments, the hydrocarbon residuum obtained from the hydroconversion-type upgrader will include solid material such as catalyst particles, sand, clay, and petroleum coke particles. Accordingly, these solid materials can be removed from hydrocarbon residuum in order to improve upgrading of the hydrocarbon residuum in the nozzle reactor. Any method of separating solid materials from the hydrocarbon residuum can be used, including filtering, screening, centrifuging, decanting, desalting, and the like. When catalyst particles are filtered out of the hydrocarbon residuum, the catalyst can be recycled back to the hydroconversion-type upgrader.

Two common methods of desalting are chemical and electrostatic separation. Each uses hot water as the extraction agent. In chemical desalting, water and chemical surfactant (demulsifiers) are added to the hydrocarbon residuum, heated so that salts and other impurities dissolve into the water or attach to the water, and then held in a tank where they settle out. Electrostatic desalting is the application of high-voltage electrostatic charges to concentrate suspended water globules in the bottom of a settling tank. Surfactants are added only when the hydrocarbon residuum has a large amount of suspended solids. Both methods of desalting are typically performed on a continuous basis. A third and less-common process involves filtering heated hydrocarbon residuum using diatomaceous earth.

In step 220, cracking material is injected into the nozzle reactor so that the hydrocarbon residuum and cracking material can interact inside of the nozzle reactor and result in the cracking and upgrading the hydrocarbon residuum. Injection of cracking material is described in greater detail above and in U.S. patent application Ser. No. 13/227,470. The process generally includes injecting cracking material, such as steam or natural gas, into the nozzle reactor and accelerating the cracking material to supersonic speed. The cracking material entering the reaction chamber at supersonic speeds creates shockwaves and generally interact with the transversely injected hydrocarbon residuum in such a way as to cause the cracking of the hydrocarbon residuum into lighter hydrocarbon molecules. Such upgrading tends to occur down the length of the reaction chamber.

In step 230, a product stream leaving the exit opening of the main passage of the nozzle reactor is collected. Any suitable means of collecting the product stream can be used. The product stream will generally include upgraded hydrocarbon molecules (i.e., those having a boiling point temperature below 1,050° F.) as well as a remainder of unconverted hydrocarbon residuum. In some embodiments, the product stream can be subjected to a separation step in order to remove the unconverted hydrocarbon residuum from the lighter hydrocarbon product produced by the nozzle reactor. Any suitable separation technique can be used, such as through the use of distillation towers. In some embodiments, the separated unconverted hydrocarbon residuum is recycled back into the nozzle reactor, including being mixed with new hydrocarbon residuum being injected into the feed port of the nozzle reactor.

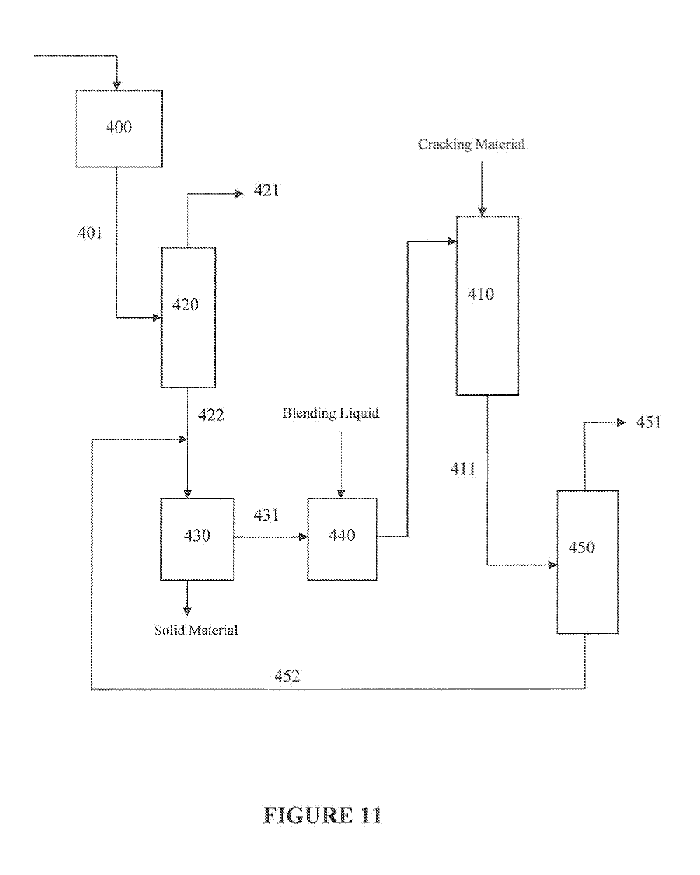

With reference to FIG. 11, a system for upgrading hydrocarbon according to embodiments described herein can generally include a hydroconversion-type upgrader 400 and a nozzle reactor 410. The hydroconversion-type upgrader 400 produces a product stream that includes unconverted hydrocarbon residuum. The unconverted hydrocarbon residuum can be injected into the nozzle reactor 410 for upgrading. Additional apparatus can also be included in the system to accomplish various conditioning, separation, and recycling functions as described in greater detail below.

The hydroconversion-type upgrader 400 can be similar to the hydroconversion-type upgrader described in greater detail above. Generally, the hydroconversion-type upgrader 400 is any type of upgrader that uses hydroconversion to upgrade hydrocarbon material injected therein. The hydroconversion-type upgrader 400 includes a product outlet through which treated hydrocarbon material 401 can be removed from the hydroconversion-type upgrader 400. Generally speaking, the material 401 that will leave the hydroconversion-type upgrader 400 will include converted light hydrocarbon material and unconverted hydrocarbon residuum. In some embodiments, the hydroconversion-type upgrader 400 of the system illustrated in FIG. 11 is an ebullating bed hydrocracker or a slurry system reactor.

The nozzle reactor 410 can be any nozzle reactor suitable for upgrading hydrocarbon material through the interaction of the hydrocarbon material and a cracking material inside of the nozzle reactor. In some embodiments, the nozzle reactor 410 of the system illustrated in FIG. 11 is similar or identical to the nozzle reactor illustrated in FIGS. 2-10 and described in greater detail above and in U.S. patent application Ser. No. 13/227,470. Generally speaking, the nozzle reactor 410 includes a main passage through which cracking material can be injected into the nozzle reactor 410 and a feed passage through which hydrocarbon material can be injected into the nozzle reactor 410 at a direction transverse to the direction of injection of the cracking material.

With continuing reference to FIG. 11, the system illustrated can also include a first separation unit 420 located downstream of the hydroconversion-type upgrader 400 and upstream of the nozzle reactor 410. The purpose of the first separation unit 420 can be to separate the product stream 401 exiting hydroconversion-type upgrader 400 into a lighter hydrocarbon material stream 421 and an unconverted hydrocarbon residuum stream 422. In this manner, the first separation unit 420 will generally include a material input for receiving the product stream 401 leaving the hydroconversion-type upgrader 400, an upgraded hydrocarbon outlet, and an unconverted hydrocarbon residuum outlet. The unconverted hydrocarbon residuum material 422 leaving the first separation unit 420 via the unconverted hydrocarbon residuum outlet can be sent to the feed passage of the nozzle reactor 410 for injection into the nozzle reactor 410.

First separation unit 420 can be any type of separation unit known to those of ordinary skill in the art and which is capable of separating the product stream 401 of the hydroconversion-type upgrader 410 into an upgraded stream 421 and an unconverted hydrocarbon residuum stream 422. In some embodiments, the first separation unit 420 is a separation unit capable of separating material based on the boiling point of the components of the material introduced into the separation unit. Exemplary separation units suitable for the first separation unit 420 include atmospheric distillation towers, vacuum distillation towers, and high pressure separators. In some embodiments, the first separation unit 420 can be a series of separation units, such as a combination of distillation towers and high pressure separators. When a series of separation units are used, the product stream 401 can be divided into several streams, each of which can include components from within a set boiling point temperature range, including a stream of unconverted hydrocarbon residuum (which can include, e.g., predominantly hydrocarbon having a boiling point higher than 1,050° F.).

The system illustrated in FIG. 11 can further include a filtering apparatus 430, which can be used to remove solid materials from the hydrocarbon residuum prior to its injection into the nozzle reactor 410. Accordingly, the filtering apparatus 430 will generally be located downstream of the first separation unit 420 and upstream of the nozzle reactor 410. Exemplary solid materials that the filtering apparatus can be designed to remove from the hydrocarbon residuum include heavy metals, spent catalyst, and petroleum coke.

Any type of filtering apparatus known to those of ordinary skill in the art and capable of separating solid materials from the liquid hydrocarbon residuum stream can be used in the system described herein. In alternate embodiments, other separation units, such as screening or decanting apparatus, can be used to separate solid materials from the hydrocarbon residuum.

The filtering apparatus 430 will generally include a material inlet for receiving the unconverted hydrocarbon residuum leaving the first separator 420 and a filtered material outlet for outputting the filtered hydrocarbon residuum 431. The filtered hydrocarbon residuum 431 can be passed to the feed passage of the nozzle reactor 410.

The system illustrated in FIG. 11 can further include a blending apparatus 440, which can be used to blend the hydrocarbon residuum with lighter hydrocarbon material to help flow characteristics prior to injection into the nozzle reactor 410. Accordingly, the blending apparatus 440 of the system illustrated in FIG. 11 will typically be located downstream of the first separation apparatus 420 and upstream of the nozzle reactor 410.

The blending apparatus 410 can be any blending apparatus known to those of ordinary skill in the art and which is capable of blending the hydrocarbon residuum with another lighter hydrocarbon material. The blending apparatus can include blending mechanisms, such as mixing blades or baffles, to promote mixing between the various materials introduced into the blending apparatus 440.

The blending apparatus 440 will generally include a material inlet for receiving the hydrocarbon residuum and a blended material outlet for outputting the blended material. The blending apparatus 440 can also include a second inlet for introducing lighter hydrocarbon material into the blending apparatus 440. In the configuration shown in FIG. 11, the material inlet of the blending apparatus 440 is in fluid communication with the filtered material outlet of the filtering apparatus 430, such that filtered hydrocarbon residuum 431 can passed along to the blending apparatus 440. Although not shown in FIG. 11, a portion of the light hydrocarbon material leaving the first separator can be introduced into the second material inlet of the blending apparatus 440 where the light hydrocarbon material is suitable for blending with the hydrocarbon residuum.

Although the system shown in FIG. 11 includes both the filtering apparatus 430 and the blending apparatus 440, the system can include either one of these units independently. That is to say, the system can include a blending apparatus 440 and exclude a filtering apparatus 430, or can include a filtering apparatus 430 and exclude a blending apparatus 440.

The system illustrated in FIG. 11 can also include a second separation unit 450 located downstream of the nozzle reactor 410. The second separation unit 450 can be provided for receiving the product material 411 leaving the nozzle reactor and separating the product material 411 into an upgraded hydrocarbon stream 451 and an unconverted hydrocarbon residuum stream 452. The second separation unit 450 can be provided in recognition of the possibility that not all of the hydrocarbon residuum injected into the nozzle reactor will be upgraded.

The second separation unit can be any type of separation unit known to those of ordinary skill in the art and which can be used to separate the product stream of the nozzle reactor 410. The second separation unit can be capable of separating the product stream 411 of the nozzle reactor based on the boiling point temperature of the components of the product stream 411. In some embodiments, the second separation unit is a distillation tower or high pressure separator.

The second separator 450 will generally include a material inlet, an unconverted hydrocarbon residuum outlet, and an upgraded hydrocarbon outlet. The material inlet will be in fluid communication with the exit opening of the main passage of the nozzle reactor 410 and will receive the product stream 411 of the nozzle reactor 410. In some embodiments, the unconverted hydrocarbon residuum outlet of the second separator 450 can provide a mechanism for passing unconverted hydrocarbon residuum 452 back into the nozzle reactor 410. As shown in FIG. 11, a recycle channel is provided wherein the hydrocarbon residuum 452 is transported to a location upstream of the nozzle reactor (such as proximate the hydrocarbon residuum leaving the first separator 420) so that the unconverted hydrocarbon residuum can be reinjected into the nozzle reactor 410 to undergo further attempts at upgrading the hydrocarbon residuum.

In some embodiments, multiple hydroconversion-type upgraders are aligned in a parallel arrangement in order to provide sufficient processing capacity for the amount of hydrocarbon residuum leaving the upstream apparatus. In such configurations, the system illustrated in FIG. 4 and described in greater detail above can be provided for each hydroconversion-type upgrader provided in the system of parallel aligned hydroconversion-type upgraders. That is to say, a nozzle reactor (and optionally a blending apparatus and/or a filtering apparatus) is provided downstream of each of the parallel aligned hydroconversion-type upgraders.

In some embodiments, two or more parallel aligned nozzle reactors can be provided down stream of the hydroconversion-type upgrader in order to provide sufficient processing capacity for the amount of hydrocarbon residuum leaving the hydroconversion-type upgrader. In such configurations, a stream splitting apparatus can be provided for dividing the stream of hydrocarbon residuum leaving the hydroconversion-type upgrader into multiple streams, with each stream being sent to a separate nozzle reactor. The stream splitting apparatus can be located upstream or downstream of optionally provided filtering apparatus or blending apparatus. If the steam splitting apparatus is located upstream of this optional equipment, than a separate filtering apparatus and blending apparatus will need to be provided for each stream produced.

In some embodiments, two or more nozzle reactors aligned in series can be provided down stream of the hydroconversion-type upgrader. Such configurations can be used to provide multiple opportunities to crack the hydrocarbon residuum material. For example, the product leaving a first nozzle reactor can be fed into a second nozzle reactor located downstream of the first nozzle reactor in order to attempt to crack any uncracked hydrocarbon residuum leaving the first nozzle reactor. Optional separation steps can be carried out between each nozzle reactor in series so that light hydrocarbon material is separated and only the heavy hydrocarbon residuum is passed through the downstream nozzle reactor.

In some embodiments, final product produced by the nozzle reactor can be blended with various other materials to form marketable liquid products. For example, the nozzle reactor product can be blended with upgraded product from a hydroconversion-type upgrader and/or with unconverted material that passes through the hydroconversion-type upgrader. Such blending can result in the production of, e.g., synthetic crude oil.

In some embodiments, the final product produced by the nozzle reactor can be separated to separate out components of the nozzle reactor product suitable for reuse in embodiments of the method described herein. In one example, fuel gas (which can account for 1 to 3 wt % of the final product) can be separated from the final nozzle reactor product and used in the hydroconversion-type upgrade as a source of H₂. The fuel gas can be separated such as by using a distillation tower. Separated gaseous fuel gas can be compressed and then sent to the H₂ supply manifold of the hydroconversion-type upgrader.

While the instant application indicates that embodiments of the nozzle reactor disclosed in U.S. patent application Ser. No. 13/227,470 can be used in various embodiments described herein, nozzle reactor configurations described in other U.S. patents and U.S. patent applications can also be used. Specifically, U.S. Pat. Nos. 7,618,597, 7,927,565, and 7,988,847, and U.S. application Ser. Nos. 12/579,193, 12/749,068, 12/816,844, 12/911,409, 13/292,747, and 61/596,826 are hereby incorporated by reference in their entirety and any embodiment of a nozzle reactor described therein can be used in embodiments described herein.

Unless otherwise indicated, all numbers or expressions, such as those expressing dimensions, physical characteristics, etc. used in the specification are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

We claim:

1. A hydrocarbon upgrading method comprising:
providing a nozzle reactor, the nozzle reactor comprising:
a main passage including a first region followed by a second region, the first region and the second region each including a convergent section, a throat, and a divergent section; and
a feed passage in fluid communication with the main passage;
wherein the feed passage meets the main passage between the throat in the first region and the throat in the second region;
injecting hydrocarbon residuum into the feed passage;
injecting a cracking material into the main passage; and
collecting a product stream exiting an exit opening of the main passage.

2. The hydrocarbon upgrading method as recited in claim 1, wherein the hydrocarbon residuum is unconverted hydrocarbon residuum collected from a hydroconversion-type upgrader.

3. The hydrocarbon upgrading method as recited in claim 2, wherein the hydroconversion-type upgrader is an ebullating bed hydrocracker.

4. The hydrocarbon upgrading method as recited in claim 1, wherein the hydrocarbon residuum comprises greater than 50 wt %+1,050° F. hydrocarbon.

5. The hydrocarbon upgrading method as recited in claim 1, further comprising:
removing solid material from the hydrocarbon residuum prior to injecting the hydrocarbon residuum into the feed passage.

6. The hydrocarbon upgrading method as recited in claim 5, wherein removing solid material from the hydrocarbon residuum includes filtering the hydrocarbon residuum.

7. The hydrocarbon upgrading method as recited in claim 1, further comprising:
blending the hydrocarbon residuum with hydrocarbon material lighter than the hydrocarbon residuum prior to injecting the hydrocarbon residuum into the feed passage.

8. The hydrocarbon upgrading method as recited in claim 7, wherein the hydrocarbon residuum accounts for greater than 50 wt % of the blend of hydrocarbon residuum and hydrocarbon material lighter than the hydrocarbon residuum.

9. The hydrocarbon upgrading method as recited in claim 7, wherein the hydrocarbon material lighter than the hydrocarbon residuum is vacuum gasoline oil (VGO).

10. The hydrocarbon upgrading method as recited in claim 1, further comprising:
separating unconverted residuum from the product stream; and
mixing the separated unconverted residuum with hydrocarbon residuum being injected into the feed passage.

11. A system for upgrading hydrocarbon comprising:
a hydroconversion-type upgrader having a product outlet; and
a nozzle reactor comprising:
a main passage including a first region followed by a second region, the first region and the second region each including a convergent section, a throat, and a divergent section; and
a feed passage in fluid communication with the main passage;
wherein the feed passage meets the main passage between the throat in the first region and the throat in the second region.

13. The system for upgrading-hydrocarbon as recited in claim 11, wherein the hydroconversion-type upgrader is an ebullating bed hydrocracker.

14. The system for upgrading hydrocarbon as recited in claim 11, further comprising:
a first separation unit comprising a material inlet, an upgraded hydrocarbon outlet, and a unconverted hydrocarbon residuum outlet, wherein the product outlet of the hydroconversion-type upgrader is in fluid communication with the material inlet of the first separation unit and the unconverted hydrocarbon residuum outlet of the first separation unit is in fluid communication with the feed passage of the nozzle reactor.

15. The system for upgrading hydrocarbon as recited in claim 11, further comprising:
a first separation unit comprising a material inlet, an upgraded hydrocarbon outlet, and a unconverted hydrocarbon residuum outlet; and
a filtering apparatus having a material inlet and a filtered material outlet;
wherein the product outlet of the hydroconversion-type upgrader is in fluid communication with the material inlet of the first separation unit, the unconverted hydrocarbon residuum outlet of the first separation unit is in fluid communication with the material inlet of the filtering apparatus, and the filtered material outlet of the filtering apparatus is fluid communication with the feed passage nozzle reactor.

16. The system for upgrading hydrocarbon as recited in claim 11, further comprising:
a first separation unit comprising a material inlet, an upgraded hydrocarbon outlet, and a unconverted hydrocarbon residuum outlet;
a filtering apparatus having a material inlet and a filtered material outlet; and
a blending apparatus having a material inlet and a blended material outlet;
wherein the product outlet of the hydroconversion-type upgrader is in fluid communication with the material inlet of the first separation unit, the unconverted hydrocarbon residuum outlet of the first separation unit is in fluid communication with the material inlet of the filtering apparatus, the filtered material outlet of the filtering apparatus is in fluid communication with the material inlet of the blending apparatus, and the blended material outlet of the blending apparatus is in fluid communication with the feed passage of the nozzle reactor.

17. The system for upgrading hydrocarbon as recited in claim 14, further comprising:
a second separation unit comprising a material inlet and a unconverted hydrocarbon residuum outlet; and
a recycle channel having a first end and a second end opposite the first end;
wherein an exit opening of the main passage is in fluid communication with the material inlet of the second separation unit, the unconverted hydrocarbon residuum outlet of the second separation unit is in fluid communication with the first end of the recycle channel, and the second end of the recycle channel is in fluid communication with the unconverted hydrocarbon residuum leaving the first separation unit.
